(19) United States
(12) Patent Application Publication
(10) Pub. No.: US 2012/0175856 A1
(43) Pub. Date: Jul. 12, 2012

(54) Tricycle With Wheelchair Platform

(76) Inventor: Robert Ellis, Brisbane (AU)

(21) Appl. No.: 13/321,495

(22) PCT Filed: May 20, 2010
(86) PCT No.: PCT/IB10/01370

§ 371 Date: Mar. 30, 2012

Related U.S. Application Data
(60) Provisional application No. 61/180,734, filed on May 22, 2009.

(51) Int. Cl. B62D 9/02; B62K 5/02

(52) U.S. Cl. 280/124.103; 180/211

(57) ABSTRACT

A vehicle includes a frame having a front portion and a rear portion, an operator's seat coupled to the frame, a front wheel steerably coupled to the front portion of the frame, a first rear wheel coupled to the rear portion of the frame, a second rear wheel coupled to the rear portion of the frame, an engine coupled to the rear portion of the frame and configured to drive the first rear wheel, and a wheelchair platform located at least partially between the first rear wheel and the second rear wheel and configured to accept a wheelchair placed in a position at least partially straddling the engine. The front portion of the frame may be rotatably coupled to the rear portion. The vehicle may further include a body, a lean angle limiting system, and/or an active lean angle system.

### BACKGROUND OF THE INVENTION

1. Field of the Invention

Embodiments of the present invention relate to vehicles. More specifically, certain embodiments relate to tricycles including leaning and/or non-leaning tricycles for disabled and/or able-bodied persons.

2. Background Art

Many people enjoy the sensation of motorcycling and bicycling but for various reasons do not desire or are unable to independently operate such a two-wheeled vehicle. Often, such people need or desire the stability of a three- or four-wheeler but enjoy the sensations of traveling in the open, on a seat with handlebars, and/or leaning into corners. For example, age or other infirmity may limit ex-cyclist's ability to safely mount and ride a two-wheeled vehicle. The ability to safely control a two-wheeled vehicle is exacerbated at low speeds, when a strong push with a healthy leg might be needed to prevent a tip-over.

Current three-wheeled solutions offer limited options. For example, in one option, the controls for a motorcycle are moved to a side car, but the resulting vehicle suffers from the handling characteristics of a motorcycle with a side car. Conventional tricycles often offer somewhat improved handling characteristics, but do not lean into corners and are difficult for the disabled to mount and ride without help. For example, wheelchair-bound persons may require assistance to transfer to the operator's seat and/or load the wheelchair onto a conventional tricycle. Some tricycles may allow the operation directly from a wheelchair, but the resulting vehicle is typically large and/or cumbersome.

What is needed is a new vehicle offering one or more of the following advantages: improved handling, a riding experience approaching that of a conventional two-wheeled motorcycle, improved accessibility for the disabled, infirm or simply timid, and/or improved low-speed characteristics.

### BRIEF SUMMARY OF THE INVENTION

Embodiments of the invention include a vehicle, comprising a frame with a front portion and a rear portion, an operator's seat coupled to the frame, a front wheel steerably coupled to the front portion of the frame, a first rear wheel coupled to the rear portion of the frame, a second rear wheel coupled to the rear portion of the frame, an engine coupled to the rear portion of the frame and configured to drive the first rear wheel, and a wheelchair platform located at least partially between the first rear wheel and the second rear wheel and configured to accept a wheelchair placed in a position at least partially straddling the engine. The front portion of the frame may be rotatably coupled to the rear portion to allow the rider/operator to lean the front portion of the frame into a turn. The vehicle may further include a body, a lean angle limiting system, and/or an active lean angle system.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art to make and use the invention.

FIGS. 1A-1B illustrate exemplary embodiments of tricycles with an engine and the ability to lean.

FIG. 2A-2B illustrates a rear view of embodiments of tricycles with an engine and the ability to lean.

FIG. 3A-3B illustrates a top view of embodiments of tricycles with an engine and the ability to lean.

FIG. 4A illustrates an embodiment of a tricycle having a ramp.

FIG. 4B illustrates an embodiment of a tricycle having a body and a ramp.

FIGS. 5A-5B illustrate an embodiment of a leaning tricycle.

FIGS. 6A-6B illustrates the operation of an exemplary lean angle limiting system.

FIG. 7 illustrates a block diagram of exemplary lean angle limiting system.

FIG. 8 illustrates an example computer system.

The present invention will now be described with reference to the accompanying drawings. In the drawings, like reference numbers may indicate identical or similar elements. Additionally, the left-most digit(s) of a reference number may identify the drawing in which the reference number first appears.

### DETAILED DESCRIPTION OF THE INVENTION

### Overview

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be used in a variety of other applications. The scope of the invention is not limited to the disclosed embodiments. The invention is defined by the claims appended hereto.

References to “one embodiment,” “an embodiment,” “this embodiment,” “an example embodiment,” etc., indicate that the embodiment described may include a particular feature, structure, or characteristic, but every embodiment might not necessarily include the particular feature, structure or characteristic. Moreover, such phrases are not necessarily referring to the same embodiment. Further, when a particular feature, structure, or characteristic is described in connection with an embodiment, it is understood that it is within the knowledge of one skilled in the art to effect such a feature, structure, or characteristic in connection with other embodiments whether or not explicitly described.

For simplicity of illustration, the following relative direction terminology is used. Up and down are relative to the earth and/or the vehicle in its normal orientation when parked normally on level ground or the roadway. Right and left directions are relative to the vehicle, i.e., the left side of the vehicle would be the rider's or driver's right as she is sitting on the driver's seat facing the typical forward direction of travel. Front, rear, forward, and aft are relative to the typical forward direction of travel, and top and bottom are relative to normal position of the vehicle sitting on level ground or roadway. The terms above, height, width, and similar terms are defined in a similar manner. All terms such as “right angle,” “centered”, “between,” “parallel” are approximate unless stated otherwise. All other directions and geometry are in defined similarly in accordance with this terminology unless specified otherwise.

### Example Embodiments

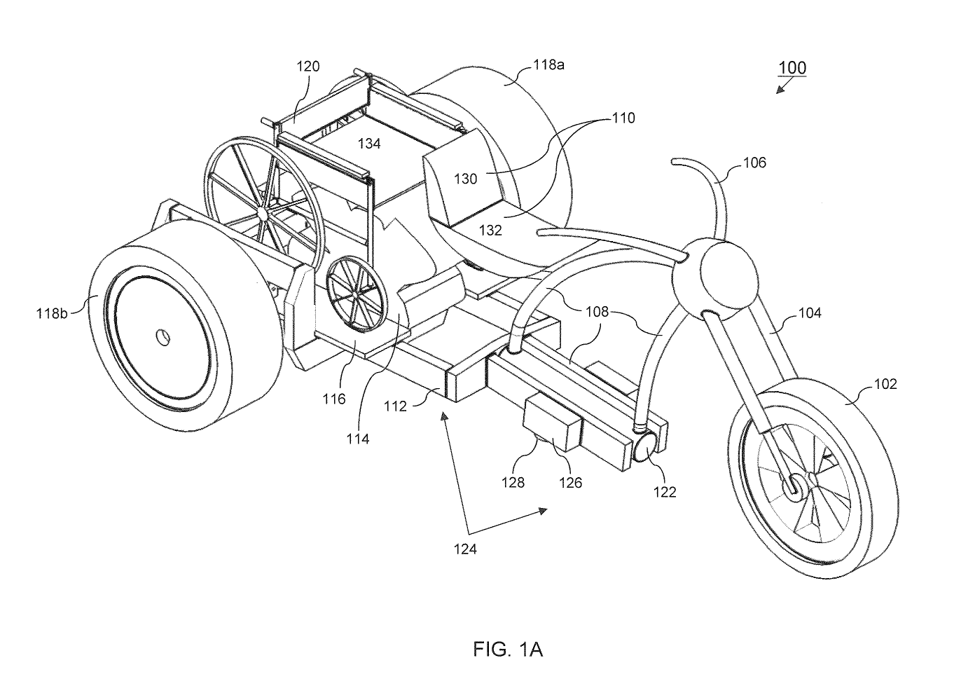

FIG. 1A illustrates an exemplary embodiment of a tricycle 100 having an optional ability to lean while cornering and also providing increased accessibility for the disabled. Tricycle 100 includes a frame 124 having a front portion 108 and a rear portion 112. Front portion 108 is coupled to rear portion 112, optionally by a pivot shaft 122. Front portion is also coupled to a front wheel 102, optionally by suspension such as front forks 104. Other mechanisms for coupling front wheel to a front portion of a frame are well-known in the art. The direction steered by front wheel 102 is controlled by a steering mechanism such as handlebars 106. Other steering mechanisms are well-known in the art. Seat 110 is also coupled to front portion 108. Seat 110 includes a seating portion 132 and optionally includes a backrest 130. In other embodiments, including non-leaning embodiments, seat 110 may be coupled to rear portion 112.

A tricycle according to embodiments of the invention may be motorized. In other embodiments, the tricycle is not motorized. In a motorized embodiment illustrated in FIG. 1, an engine 114 is coupled to (i.e., mounted in, mounted on, or made an integral part of) rear portion 112. Engine 114 provides the driving force for driving one or more rear wheels such as rear wheel 118a and/or rear wheel 118b. Engine 114 may drive wheel(s) 118 via a transmission and/or clutch as is known in the art (not shown). Engine 114 may be any mechanism for providing a motive force such as an internal combustion engine, an electric motor, or hybrid of two or more technologies.

Wheelchair platform 116 is also coupled to rear portion 112 such that an exemplary wheelchair 120 may be placed and/or fastened to wheelchair platform 116. In another embodiment, wheelchair platform 116 is formed by rear portion 112 (i.e., a surface of rear portion 112 serves as a wheelchair platform). Fastening mechanisms (not shown) such as wheel straps, clips, clamps, etc. may be used to secure wheelchair 120 in position on platform 116. In an embodiment, wheelchair platform 116 is configured to allow the placement of wheelchair 120 in a straddling position as illustrated in FIG. 1A, wherein at least a portion of engine 114 is between at least two wheels of wheelchair 120, i.e., wheelchair 120 is straddling at least a portion of engine 114.

Wheelchair 120 may be any standard-sized or custom-built wheelchair designed for an adult, but is preferably a wheelchair for adults between the 5th and 95th percentile in size. Wheelchair style may be any style, including standard, folding or rigid, motorized, lightweight, ultra-lightweight, or transport wheelchairs, but is preferably a manual, user-propelled (non-transport) wheelchair.

In embodiments that lean and include a pivot shaft 122, pivot shaft 122 may be constrained in the axial and/or radial directions by one or more bearings (not shown in FIG. 1A). Pivot shaft 122 is free to rotate to some degree, however, allowing front portion 108 to rotate relative to rear portion 112. The possible angle of rotation may be optionally constrained with hard stops or dynamically adjustable mechanisms such as a cam 128. Cam 128 may be controlled by a cam actuator 126. Cam actuator 126 and cam 128 are components of an exemplary lean angle limiting system discussed in detail elsewhere herein.

FIG. 1B illustrates an embodiment of tricycle 100 wherein backrest 130 of seat 110 is configured to lean back or recline (e.g., such as having a hinge or other mechanism as known in the art) to allow a person to easily transfer from wheelchair 120 to seat 110. The height of seating portion 132 may be fixed or adjustable. In an embodiment, the height of seating portion 132 is placed (fixed or adjusted) such that a wheelchair seat 134 is approximately the height of seating portion 132 relative to the ground when wheelchair 120 is positioned on wheelchair platform 116. As shown in FIGS. 1A and 1B, wheelchair platform 116 is positioned and configured such that a seat 134 of a wheelchair 120 positioned on the wheelchair platform is rearward of and substantially adjacent to the operator's seat. In another embodiment, any difference in heights is at least partially compensated for by backrest 130—i.e., backrest 130 may be positioned so that it does not lay flat, but is angled downward or upward to allow a person to easily transfer from wheelchair seat 134 to seating portion 132 or seating portion 132 to wheelchair seat 134. In embodiments without backrest 130, seat 110 is preferably at a height such that the transfers from one seat to the other are facilitated. In such embodiments, seating portion 132 may be approximately the same height as wheelchair seat 134. For example, the Americans With Disabilities Act Guidelines for Buildings and Facilities (ADAAG) as amended through Aug. 5, 2005 generally considers that adult wheelchair users are able to transfer to a seat or bench of the same height as the “typical” adult wheelchair seat, i.e., a height of 17″-19″ from the floor. Thus, in an embodiment, at least a portion of seat 110 may be fixed or adjusted to be within the range of approximately 17″ to approximately 19″ above a plane formed by wheelchair platform 116. Seat 110 need not be flat and may include a fixed or adjustable ramped portion to facilitate transfers to and from wheelchair 120.

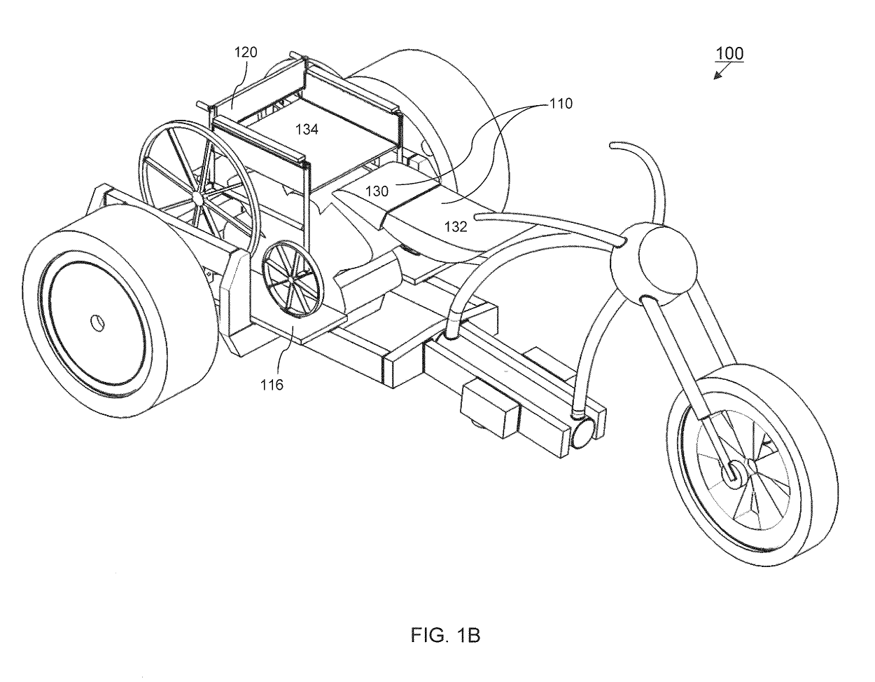

FIG. 2A illustrates a rear view of exemplary tricycle 100. At least a portion of engine 114 is positioned between rear wheels 118a and 118b. Also, at least a portion of wheelchair platform 116 is positioned between rear wheels 118a and 118b and on each side of at least a portion of engine 114. FIG. 2B illustrates a rear view of exemplary tricycle 100 with an exemplary wheelchair 120 placed on and/or fastened to wheelchair platform 116. In an embodiment, wheelchair platform 116 is configured to allow the placement of wheelchair 120 in a straddling position as illustrated in FIG. 2B, wherein at least a portion of engine 114 is underneath at least a portion of wheelchair 120. In one embodiment, wheelchair platform 116 and engine 114 are approximately laterally centered between rear wheels 118 (i.e., centered along an axis that extends laterally through wheels 118 in the plane of the drawing sheet). While this centered position is preferred in one embodiment, it is not required.

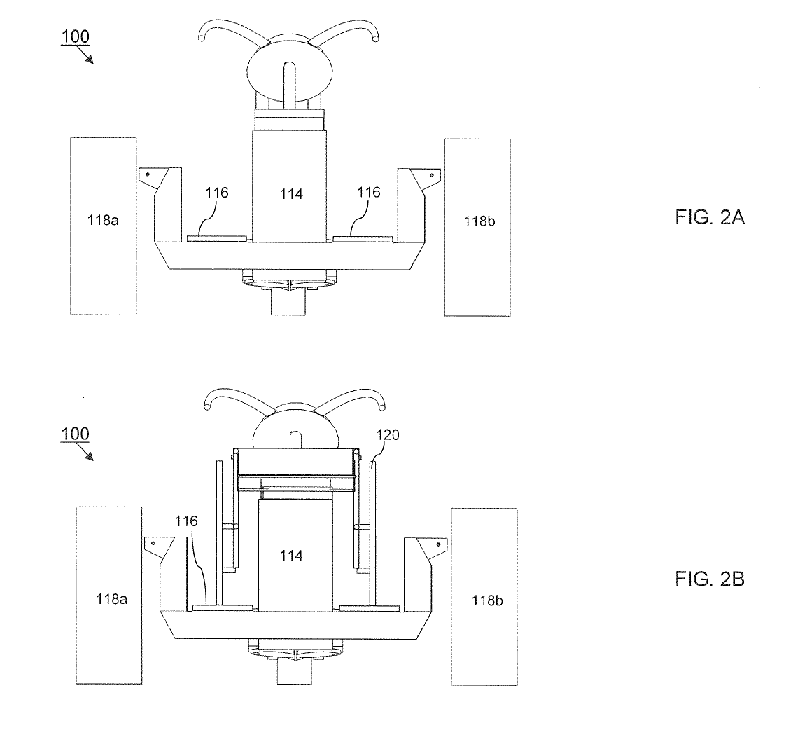

FIG. 3A illustrates a top view of exemplary tricycle 100. In the illustrated exemplary embodiment, in addition to being laterally centered, wheelchair platform 116 is also approximately centered between rear wheels 118 along a longitudinal axis of frame 124. In this embodiment, engine 114 is positioned along the longitudinal axis, slightly forward of a lateral axis through the center of rear wheels 118. In another embodiment, wheelchair platform 116 is centered aft or forward of rear wheels 118 along the longitudinal axis.

In the example embodiment of FIG. 3, wheelchair platform 116 is shown as including two separate pieces. In another embodiment, wheelchair platform 116 may include, for example, a single piece (or multiple pieces coupled together) to form a “U” or oval shape. At least a portion of engine 114 is located between rear wheels 118a and 118b and is at least partially circumscribed by wheelchair platform 116 as viewed from the top. Seat 110, which optionally includes backrest 130 and seating portion 132, is positioned forward of at least a portion of engine 114. As illustrated in FIG. 3B, seat 110 is positioned such that a person may transfer forward from a wheelchair 120 placed on or attached to wheelchair platform 116 to seat 110.

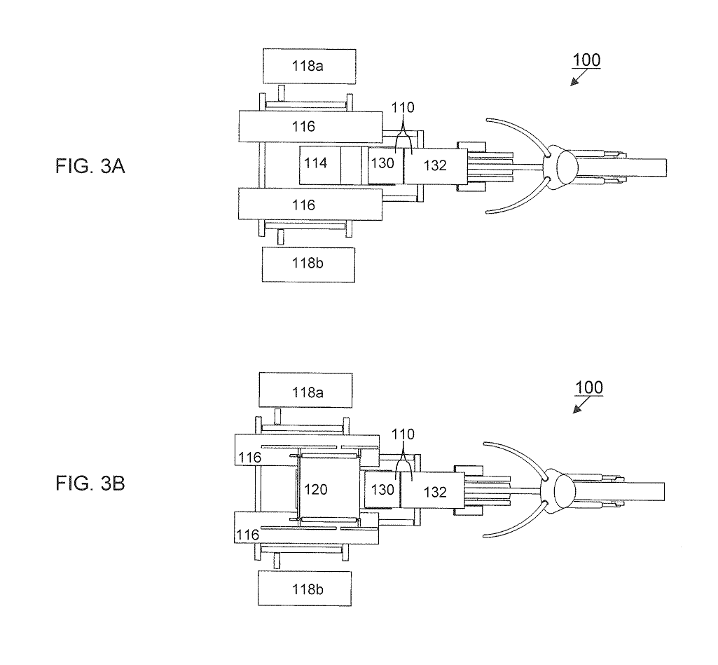

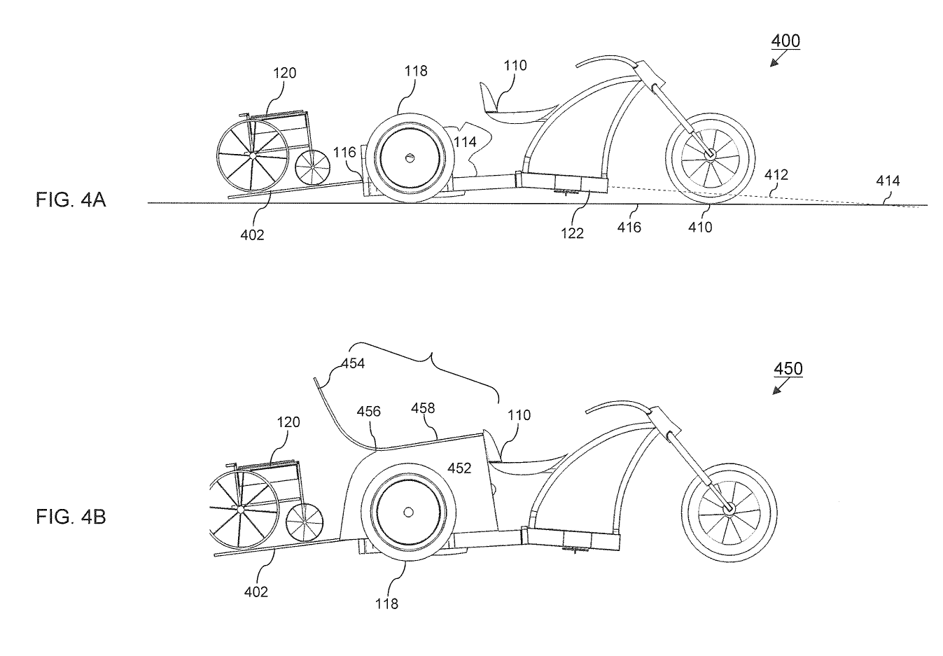

FIG. 4A illustrates an embodiment of an exemplary tricycle 400. Tricycle 400 is similar to examples previously described with the addition of a ramp 402 which may be used to load wheelchair 120 onto wheelchair platform 116. Ramp 402 is coupled to tricycle 400 at or near wheelchair platform 116 between and preferably behind at least a portion of engine 114 and the centers (i.e., axles) of rear wheels 118. Ramp 402 may be coupled to tricycle 400 at other locations, however. The wheelchair user may propel herself up and/or down ramp 402. Alternatively, a motorized assist mechanism, such as a winch or latching mechanism (not shown) may fasten to the chair to assist traveling up and/or down ramp 402. Ramp 402 may slide or fold into place when not in use.

FIG. 4B illustrates an exemplary embodiment of tricycle 450 having a at least partially enclosed body 452. Body 452 as shown does not cover rear wheels 118. In another embodiment, however, body 452 covers rear wheels 118 as a single piece or with separate fenders. Body 452 as shown does not cover seat 110. In another embodiment, however, body 452 may extend to cover at least a portion of seat 110 and/or a seated rider (e.g., may include a roof). Body 452 may include signal lights such as brake, tail, running and turn signal lights (not shown). Additional body 452 components (not shown) may cover portions of tricycle 450 forward of seat 110 and may include a windscreen or windshield.

Body 452 may improve the visual appearance of tricycle 450. Body 452 may also shield internal components and wheelchair 120 from view. Embodiments of body 452 may require the use of a certain wheelchair configuration such as a wheelchair with a fold-down chair back. Body 452 may also protect wheelchair 120 and/or other components including a rider from the elements (e.g., wind, rain, sun, etc.). Body 452 may include a door 454 which may be coupled by a coupling 456 to body 454. Coupling 456 may be a hinge or equivalent mechanisms to allow door 454 to open and shut. Alternatively, door 454 may be flexible and require no coupling 456. In another embodiment, door 454 is hinged on the right or left side and swings out of the way. Further, door 454 may be lifted out of the way such as by using a hydraulic mechanism. Door 454 may also include a latch and/or lock (not shown). Tricycle 450 also optionally includes ramp 402 for wheelchair 120 as described above. Additionally, a lid 458 may be hinged on the left or right side, allowing lid 458, with or without door 454, to swing to the side and allow wheelchair 120 to be ridden up ramp 402. Lid 458 may also be lifted up and out of the way, such as with a hydraulic mechanism, with or without door 454. The front of body 452 may be open to allow the rider to transfer forward to seat 110, or may alternatively be equipped with one or two hinged or otherwise movable panels.

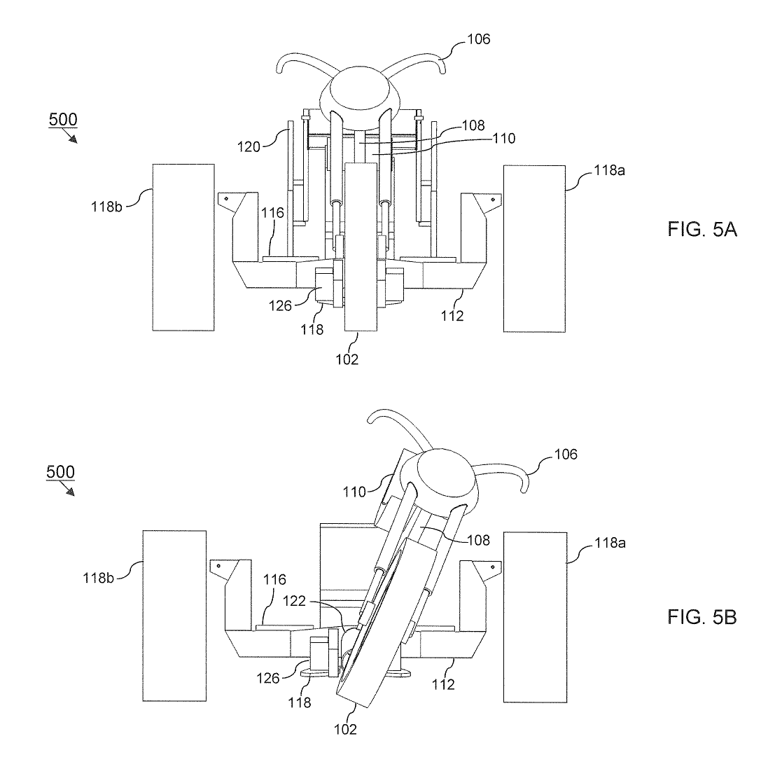

FIGS. 5A-5B illustrates an exemplary tricycle 500 having the ability to tilt or lean. A leaning tricycle 500 is shown in an upright position and a leaned-over position in FIGS. 5A-5B respectively. Tricycle 500 is a simplified example meant to illustrate the leaning feature, and may include various combinations of other features elsewhere herein regardless of whether they are shown in FIGS. 5A-5B. Tricycle 500 includes a frame having a front portion 108 and a rear portion 112. Front portion 108 is coupled to rear portion 112 by, for example, pivot shaft 122 (obscured by front wheel 102 in FIG. 5A). Other mechanisms for rotatably coupling rear portion 112 to front portion 108 at a rotation point (i.e., to allow leaning) may be used in leaning tricycle 500, such as a ball joint, bearings including plain bearings, bushings, and rolling bearings, clevis assembly, etc. Front portion is also coupled to seat 110 and front wheel 102. The direction steered by front wheel 102 is controlled by a steering mechanism such as handlebars 106. Rear wheels 118 are coupled to rear portion 112. Embodiments may include optional wheelchair platform 116, on which an optional wheelchair 120 may be placed or mounted. Optional wheelchair platform 116 may be coupled to rear portion 112 as described above. FIG. 5B omits the wheelchair for clarity.

Pivot shaft 122 may be constrained in the axial and/or radial directions by one or more bearings (not shown). Pivot shaft 122 may rotate, however, allowing front portion 108 to rotate relative to rear portion 112. The possible angle of rotation of pivot shaft 112 may be optionally constrained with hard stops or dynamically adjustable mechanisms such as a cam 128. Cam 128 may be controlled by a cam actuator 126. Cam actuator 126 and cam 128 are components of an exemplary lean angle limiting system discussed in detail elsewhere herein. Under normal operation, front portion 108 rotates (i.e., leans) while rear portion 112 maintains its orientation with respect to the ground or road surface. Thus, a rider on seat 110 leans with the front portion, while rear portion maintains a level orientation to the roadway.

Referring back to FIG. 4A, the angle of pivot shaft 122 determines, in part, the handling characteristics of a leaning tricycle. An imaginary pivot axis 412 of pivot shaft 122 may be extended out to an ideal flat roadway 416. An intersection point 414 of pivot axis 412 with ideal flat roadway 416 may occur forward of, at, or behind front tire contact point 410 with the roadway. If intersection point 414 and front tire contact point 410 coincide, there will be no rear wheel steering. In the example shown in FIG. 4A, intersection point 414 is forward of front tire contact point 410. Thus, in the example shown the rear wheels will turn in the direction of the lean, which has an effect on handling. If intersection point 414 is behind front tire contact point 410, then the rear wheels will turn opposite the leaned angle, which has another effect on handling. Although the neutral handling characteristics that result when intersection point 414 is approximately equal to front tire contact point 410, other factors may determine the final design decision. For example, the an angle of pivot shaft 122 in a particular embodiment may also be influenced by other factors, such as ground clearance and ease of manufacturing. Different implementations balance these factors to achieve the desired results.

A leaning tricycle may have an active or passive lean angle system. For the purposes of this document, an “active” lean angle system determines and sets a vehicle's lean angle using, for example, a combination of sensors, an angle determining unit, and a driver to deliver the moment of force necessary to drive the correct lean angle. Sensors may include accelerometers (e.g., to sense “forces” or accelerations experienced by the vehicle such as centrifugal force while rounding a corner), steering angle sensors, speed sensors, etc. An angle determining unit may include, for example, an analog or digital system configured to compute a lean angle based on sensor input including feedback based on the current lean angle. A driver may include, for example, synchro motors and/or hydraulic actuators to put the vehicle at a lean angle determined by the angle determining unit.

Lean angle may also be “passively” determined. As defined for the purposes of this document, passive lean angle determination is the achievement and maintenance of a lean angle at speed based on vehicle chassis geometry, speed, and rider inputs—i.e., much like a conventional motorcycle or bicycle. As riders of bicycles and motorcycles intuitively if not consciously understand, lean angle is “automatically” determined as a function of torque exerted on the handlebars, rider position and overall vehicle mass distribution, vehicle geometry (e.g., rake, trail, wheelbase), turn radius, and forward speed. Embodiments of the invention that lean may use active, passive, or a hybrid of active and passive lean angle determination. In addition, other systems, such as the example system for limiting lean angle (described herein) may be used to enhance lean angle control.

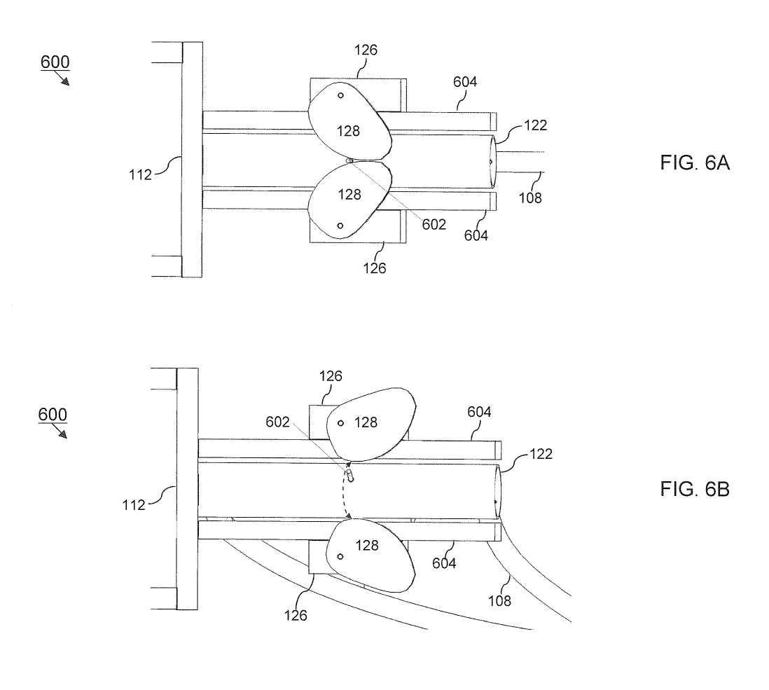

FIGS. 6A-6B illustrates the operation of an exemplary lean angle limiting system 600. FIGS. 6A-6B are a bottom view of a portion of, for example, tricycle 500 as illustrated in FIGS. 5A-5B. Lean angle limiting system 600 includes cams 128 and cam actuators 126. Cams 128 and cam actuators 126 may be coupled to rear frame 112 directly or indirectly. In this example embodiment, cams 128 are coupled to cam actuators 126, which are in turn coupled to a pair of pivot shaft side bars 604. Pivot shaft side bars 604 are coupled to rear portion 112 of the frame. Pivot shaft 122 is coupled to front portion 108 of frame 124 such that pivot shaft 122 rotates relative to cams 128. A pivot shaft peg (e.g., a pin protruding radially from pivot shaft 122) is fixed to pivot shaft 122.

Cams 128 operate on pivot shaft peg 602. Thus, when cams 128 are rotated to the position shown in FIG. 6A, pivot shaft peg 602 is constrained by cams 128 and pivot shaft 122 is not free to rotate. When cams 128 are rotated to the position shown in FIG. 6B, pivot shaft peg is free to move in the space between cams 128, and pivot shaft 122 is free to rotate in the corresponding range illustrated by the arc before contacting cams 128. Thus, in FIG. 6A, front portion 108 is locked in the “upright” position. In FIG. 6B, however, front portion 108 is able to lean a number of degrees (e.g., ±30°) to each side limited by pivot shaft peg 602 and the positions of cams 128. In an embodiment, the maximum lean angle achievable, i.e., when the cams are rotated to allow maximum rotation, is limited by other components (e.g., footpegs) contacting the ground.

In exemplary lean angle system 600, the illustrated components of the example lean angle limiting system are shown operating on the bottom of pivot shaft 122. Other orientations are possible—i.e., a pivot shaft peg with rotatable cams on each side could be placed on the side or top of a pivot shaft.

Cams 128 may be rotated by cam actuators 126 based on the speed of the vehicle. For example, at slow speeds (e.g., speeds less than a set point such as five miles per hour (mph)), cams 128 could be positioned as shown in FIG. 6A, thus locking front portion 108 of a tricycle in the upright position. As speed increases, cams 128 may be rotated towards the position illustrated in FIG. 6B. As speed increases further, cams 128 may be rotated completely clear of any possible shaft pivot peg position. Alternatively, cams 128 may always limit the maximum lean angle because of their shape and size and/or a maximum allowable rotation.

Cam actuators 126 rotate cams 128. A cam may be directly coupled to a cam actuator (e.g., attached to its shaft). A cam may also be indirectly coupled to a cam actuator, such as by a gearing arrangement (e.g, a worm drive). Cam actuators may be any mechanism that provides the required motion (e.g., electric motors including synchro motors and stepper motors, various types of servomotors, amplidynes, hydraulic motors, etc.).

Although cam actuators 126 are shown co-located with cams 128 in the examples illustrated in FIGS. 6A-6B, this need not be the case. For example, cam actuators 126 could be mounted to frame 112 and could drive cams 128 through one or more shafts and/or an indirect coupling such as a gear arrangement. Furthermore, both cams 128 could be coupled to a single cam actuator by various mechanisms such as a gearing arrangement and shafts.

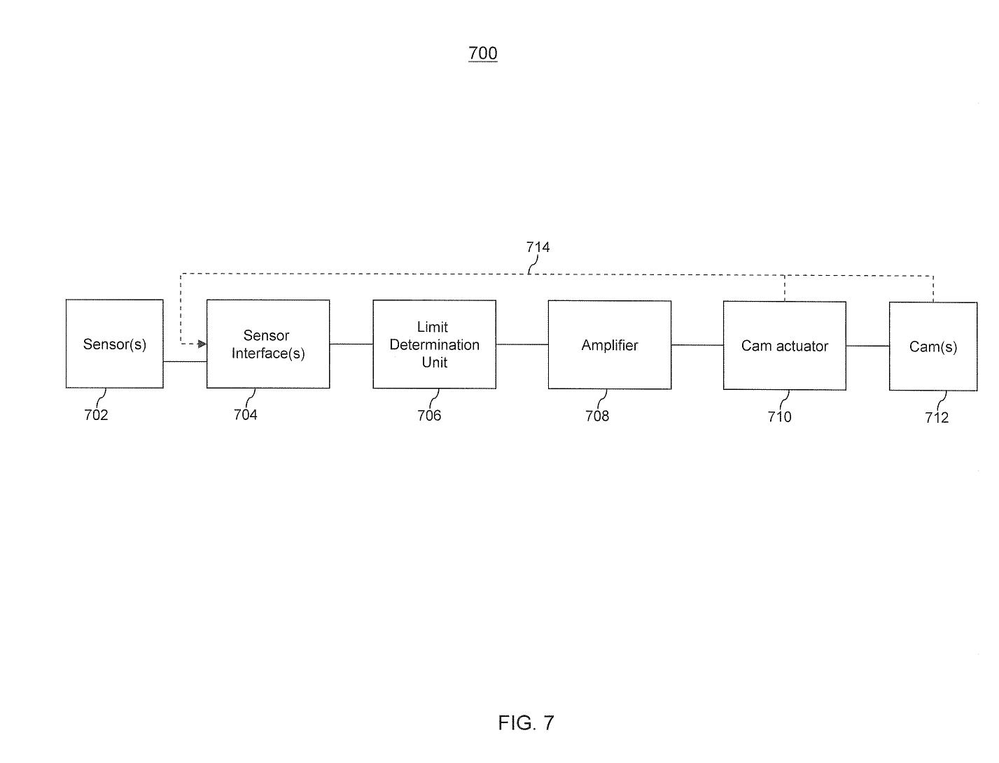

An exemplary lean angle limiting system may gather sensor information such as current speed and determine a maximum desired lean angle using digital and/or analog components. FIG. 7 illustrates a block diagram of an exemplary lean angle limiting system 700. One or more sensors 702 provide inputs to a sensor interface 704. Sensor(s) 702 may include sensors from other systems (e.g., a speed sensor for a speedometer system may be used). Sensors may be mechanical (e.g., a rotating speedometer cable), electrical or electro-mechanical (e.g., analog electrical signals or pulses or voltage levels based on switch positions) or electronic (analog or digital). Sensors gather information including operator-positioned switch indications. Exemplary sensors include an override sensor (e.g., senses a position of an override switch used for maintenance or by the operator), a speed sensor, a transmission gear sensor, etc. One or more sensor interface(s) 704 gather the inputs from sensor(s) 702. For inputs in certain formats, a sensor interface may be a simple electrical connector or mechanical connection. In other cases, sensor data may require conversion (e.g., convert a mechanical signal to an analog or digital electronic signal). Thus, a sensor interface 704 may include multiple subcomponents. Sensor interface(s) 704 send properly formatted mechanical, electrical or electronic signals to a limit determination unit 706. Limit determination unit 706 may be mechanical, electro-mechanical, electrical, or electronic. Limit determination unit 706 receives formatted signals from one or more sensor interface(s) 704 and determines the proper lean angle limit. A mechanical, electrical, or electronic signal corresponding to the proper lean angle limit may be sent to an optional amplifier 708. Amplifier 708 may be electronic, electrical, mechanical, or electro-mechanical. Amplifier 708 and limit determination unit 706 may be implemented in one inseparable unit. Also, limit determination may include internal amplification of an output signal in addition to a separate amplifier 708. Amplifier 708 amplifies the received signal and sends it to one or more cam actuators 710. Amplifier 708 and cam actuator 710 may be implemented in one inseparable unit. Also, cam actuator 710 may include internal amplification of an input signal received from a separate amplifier 708. Cam actuator 710 is configured to position one or more cam(s) 712. Lean angle determining systems may be open loop or closed loop. Thus, as illustrated in FIG. 7, an example lean angle determining system may include feedback loop 714, which gathers cam position from cam actuator 710 and/or cam(s) 712 and sends the data to sensor interface(s) 704.

Maximum desired lean angle profiles can be implemented using a lean angle limiting system such as system 700. For example, at 15 miles per hour and above, there may be no limit to the lean angle (other than maximum possible lean such as maximum cam rotation, a mechanical stop or limits imposed by the vehicle chassis or the roadway). For each mile per hour below 15 miles per hour, each cam 712 may be rotated to limit lean angle a greater amount until the front portion of the tricycle is locked in an upright position at five miles per hour. This adjustment may be continuous or stepwise (e.g, cams 712 are rotated in steps as one or more speed set points are passed).

Lean angle limiting system 700 may have a single, static lean angle profile or may have more than one profile selectable by the user. For example, in addition to the profile described above, lean angle limiting system may have a “conventional tricycle” mode which always locks the front portion in the upright position, a “beginner” mode which limits lean angle more aggressively than the above described example, and an “expert” mode which limits lean angle only at speeds below a specific amount (e.g., three or five miles per hour). If limit determination unit 706 is a microprocessor-based system, an practically infinite number of different profiles may be established.

The shapes and sizes of cams 712 determines the amount that maximum lean angle is affected for a given amount of cam 712 rotation. Also, depending on a cam's profile, one degree of rotation may have the same or different effects depending on the initial rotational position of the cam. Thus, the implementation of limit determination unit 706 may take into account the position, size, and profile of a cam 712.

Limit determination unit 706 may be implemented as a mechanical and/or electrical (digital and/or electronic) system. In one embodiment, limit determination unit 706 may is a microprocessor-based system configured by program instructions stored in memory (e.g., RAM, ROM, flash memory, magnetic storage device or optical memory device). Example software used by a limit determination unit may include the steps of receiving vehicle speed, determining desired cam position, and outputting desired cam position. Determination of the desired cam position may be implemented as a table look-up or calculated as a dynamic or pre-determined function of vehicle speed.

### Example Computer System

Various aspects of the present invention can be implemented by software, firmware, hardware, or a combination thereof. Calculations may be approximated using table look-ups. Hardware implementations of individual components are not limited to digital implementations and may be analog electrical circuits. Additionally, embodiments may be realized in a centralized fashion in at least one communication system, or in a distributed fashion where different elements may be spread across several interconnected communication systems. Any kind of computer system or other apparatus adapted for carrying out the methods described herein may be suited.

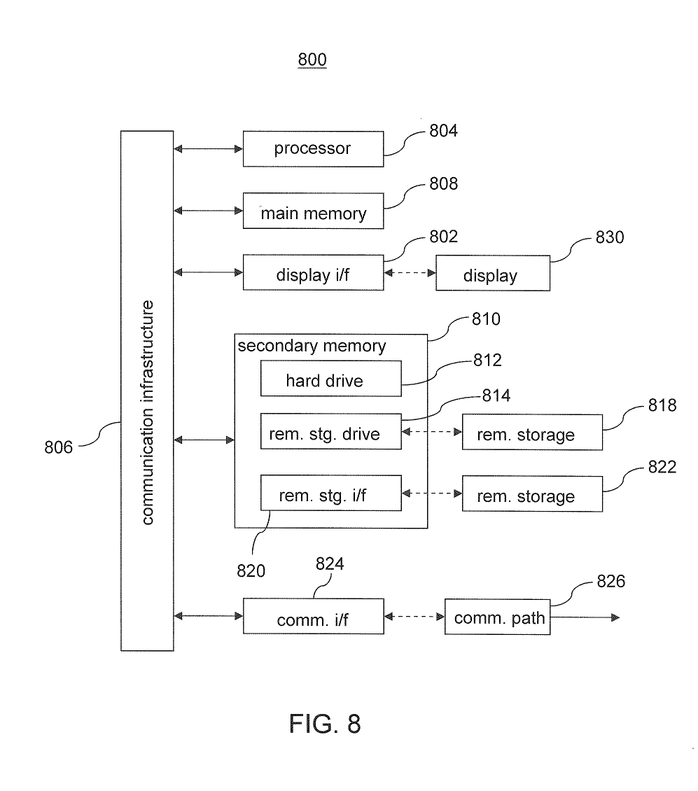

FIG. 8 illustrates an example computer system 800 in which the present invention, or portions thereof, can be implemented as computer-readable code. For example, the limit determination unit 706 of FIG. 7 can be implemented using system 800. Various embodiments of the invention are described in terms of this example computer system 800. After reading this description, it will become apparent to a person skilled in the relevant art how to implement the invention using other computer systems and/or computer architectures.

Computer system 800 includes one or more processors, such as processor 804. Processor 804 can be a special purpose or a general purpose processor. Processor 804 is connected to a communication infrastructure 806 (for example, a bus or network).

Computer system 800 also includes a main memory 808, preferably random access memory (RAM), and may also include a secondary memory 810. Secondary memory 810 may include, for example, a hard disk drive 812, a removable storage drive 814, any type of non-volatile memory, and/or a memory stick. Removable storage drive 814 may comprise a floppy disk drive, a magnetic tape drive, an optical disk drive, a flash memory, or the like. The removable storage drive 814 reads from and/or writes to a removable storage unit 818 in a well known manner. Removable storage unit 818 may comprise a floppy disk, magnetic tape, optical disk, etc. which is read by and written to by removable storage drive 814. As will be appreciated by persons skilled in the relevant art(s), removable storage unit 818 includes a computer usable storage medium having stored therein computer software and/or data.

In alternative implementations, secondary memory 810 may include other similar means for allowing computer programs or other instructions to be loaded into computer system 800. Such means may include, for example, a removable storage unit 822 and an interface 820. Examples of such means may include a program cartridge and cartridge interface (such as that found in video game devices), a removable memory chip (such as an EPROM, or PROM) and associated socket, and other removable storage units 822 and interfaces 820 which allow software and data to be transferred from the removable storage unit 822 to computer system 800.

Computer system 800 may also include a communications interface 824. Communications interface 824 allows software and data to be transferred between computer system 800 and external devices. Communications interface 824 may include a modem, a network interface (such as an Ethernet card), a communications port, a PCMCIA slot and card, or the like. Software and data transferred via communications interface 824 are in the form of signals which may be electronic, electromagnetic, optical, or other signals capable of being received by communications interface 824. These signals are provided to communications interface 824 via a communications path 826. Communications path 826 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 818, removable storage unit 822, and a hard disk installed in hard disk drive 812. Signals stored elsewhere and carried over communications path 826 can also embody the logic described herein. Computer program medium and computer usable medium can also refer to memories, such as main memory 808 and secondary memory 810, which can be memory semiconductors (e.g. DRAMs, etc.). These computer program products are means for providing software to computer system 800.

Computer programs (also called computer control logic) are stored in main memory 808 and/or secondary memory 810. Computer programs may also be received via communications interface 824. Such computer programs, when executed, enable computer system 800 to implement the present invention as discussed herein. In particular, the computer programs, when executed, enable processor 804 to implement the processes of the present invention, such as the steps of determining and setting lean angle discussed above. Accordingly, such computer programs represent controllers of the computer system 800. Where the invention is implemented using software, the software may be stored in a computer program product and loaded into computer system 800 using removable storage drive 814, interface 820, hard drive 812 or communications interface 824.

### Conclusion

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, the present invention should not be limited to particular embodiments disclosed, should be defined in accordance with the following claims and their equivalents.

What is claimed is:

1. A vehicle, comprising:
a frame comprising a front portion and a rear portion;
an operator's seat coupled to the frame;
a front wheel steerably coupled to the front portion of the frame;
a first rear wheel coupled to the rear portion of the frame;
a second rear wheel coupled to the rear portion of the frame;
an engine coupled to the rear portion of the frame, and configured to drive the first rear wheel; and
a wheelchair platform on the rear portion of the frame located at least partially between the first rear wheel and the second rear wheel and configured to accept a wheelchair placed in a position at least partially straddling the engine.

2. The vehicle of claim 1, wherein the wheelchair platform is positioned and configured such that a seat of a wheelchair positioned on the wheelchair platform is rearward of and adjacent to the operator's seat.

3. The vehicle of claim 2, wherein the wheelchair platform is positioned and configured such that a seat of a wheelchair positioned on the wheelchair platform is approximately the same height as the operator's seat.

4. The vehicle of claim 1, wherein the wheelchair platform is formed by at least one surface of the rear portion of the frame.

5. The vehicle of claim 1, wherein the engine is located at least partially between the first rear wheel and the second rear wheel.

6. The vehicle of claim 1, wherein the front portion is coupled to the rear portion to allow the front portion to rotate with respect to the rear portion along a substantially constant axis.

7. The vehicle of claim 6, wherein the front portion is rotatably coupled to the rear portion by a mechanism including a pivot shaft.

8. The vehicle of claim 6, wherein the operator's seat is coupled to the front portion of the frame.

9. The vehicle of claim 8, wherein the operator's seat includes a backrest configured to recline.

10. The vehicle of claim 1, further comprising a body coupled to the rear portion.

11. The vehicle of claim 10, wherein the body is configured to house a wheelchair on the wheelchair platform.

12. The vehicle of claim 6, further comprising a lean angle limiting system coupled to the frame.

13. The vehicle of claim 12, wherein the lean angle limiting system comprises:
a pair of cams; and
a cam actuator coupled to the cams.

14. The vehicle of claim 12, wherein the lean angle limiting system comprises a limit determination unit configured to determine a maximum allowed lean angle.

15. The vehicle of claim 14, wherein the limit determination unit is configured to determine the maximum allowable lean angle based on a speed of the vehicle.

16. The vehicle of claim 14, wherein the limit determination unit comprises a computer system having a processor and memory coupled to the processor.

17. The vehicle of claim 8, further comprising an active lean angle system configured to determine and impose a lean angle on the front portion.

18. A vehicle, comprising:
a frame comprising
a front portion,
a rear portion, and
a rotatable mechanism coupling the front portion to the rear portion and configured to allow the front portion to rotate with respect to the rear portion along a substantially constant axis;
an operator's seat coupled to the frame;
a front wheel steerably coupled to the front portion of the frame;
a first rear wheel coupled to the rear portion of the frame;
a second rear wheel coupled to the rear portion of the frame;
an engine coupled to the rear portion of the frame, and configured to drive the first rear wheel; and
a wheelchair platform on the rear portion of the frame located at least partially between the first rear wheel and the second rear wheel and configured to accept a wheelchair placed in a position at least partially straddling the engine.

19. The vehicle of claim 18, further comprising a lean angle limiting system coupled to the frame.

20. The vehicle of claim 19, wherein the lean angle limiting system comprises:
a pair of cams; and
a cam actuator coupled to the cams.
